(19) United States
(12) Patent Application Publication
(10) Pub. No.: US 2013/0042080 A1
(43) Pub. Date: Feb. 14, 2013

(54) PREVENTION OF RACE CONDITIONS IN LIBRARY CODE THROUGH MEMORY PAGE-FAULT HANDLING MECHANISMS

(71) Applicants: Daniel G. WADDINGTON, Morgan Hill, CA (US); Chen TIAN, Union City, CA (US); Tongping LIU, Amherst, MA (US)

(72) Inventors: Daniel G. WADDINGTON, Morgan Hill, CA (US); Chen TIAN, Union City, CA (US); Tongping LIU, Amherst, MA (US)

(73) Assignee: SAMSUNG ELECTRONICS CO., LTD., Suwon City (KR)

(21) Appl. No.: 13/425,312

(22) Filed: Mar. 20, 2012

Related U.S. Application Data
(60) Provisional application No. 61/523,231, filed on Aug. 12, 2011.

(51) Int. Cl. G06F 12/14

(52) U.S. Cl. 711/152; 711/E12.102

(57) ABSTRACT

Protection of shared data in a multi-core processing environment is disclosed. A page-fault handling mechanism is adapted to synchronize access to shared memory. An application of the present invention is for synchronizing access to potentially shared data, where the shared data is opaque in that it does not have a well-defined structure.

### CROSS REFERENCE TO RELATED APPLICATIONS

The present application claims the benefit of U.S. provisional App. Ser. No. 61/523,231, filed on Aug. 12, 2011, the contents of which are hereby incorporated by reference.

### FIELD OF THE INVENTION

The present invention is generally related to synchronizing access to shared data in a multicore processor environment. More particularly, the present invention is directed to the use of single-threaded (i.e., uniprocessor) legacy code in a multicore processor environment.

### BACKGROUND OF THE INVENTION

Software that is designed to run on multicore and manycore processors (also known as Chip Multiprocessors—CMP) must be explicitly structured for correctness in the presence of concurrent execution. Most multicore processors today support coherent shared memory (known as SMP—Symmetric Multi-Processing) which allows multiple threads of execution, running on separate cores (on potentially separate processor packages), to access the same physical memory space. Coherency, meaning that a consistent view of memory is observed by all cores, is achieved typically through hardware coherency protocols at the cache level (e.g., Modified Exclusive Shared Invalid (MESI)).

An important element of correctness within an SMP environment is ensuring that accesses to data are serialized in order to ensure atomicity in data writes. For example, given Thread A (running on core 0) is writing a 64-bit integer (e.g., variable v) in memory (on a 32-bit machine), two memory operations/transactions on the memory controller, are needed to achieve the goal. Without correct synchronization, a Thread B might read the first half of the memory location before Thread A has completed writing the second half results in an inconsistent and incorrect result. To avoid this problem, read and write access to variable ‘v’ should be synchronized through some form of lock or mutual exclusion mechanism (e.g., spinlock, mutex, semaphore) that can be realized on the specific processor.

However, due to the relatively recent advent of multicore processors, legacy library code is usually not “thread safe.” This is because legacy library code was often originally designed to execute only in a uniprocessor environment. There are several possible solutions to the reuse of uniprocessor code in a multicore processor environment. These include: 1) rewriting legacy code, which has the disadvantages of requiring a time consuming process in which the source code may not be available; and 2) placing a lock around every legacy/library call to serialize the execution of every call, even those that cannot cause race conditions.

### SUMMARY OF THE INVENTION

The present invention is directed to using a page-fault mechanism to safely manage access to shared data across multiple concurrent threads of an SMP environment. An exemplary application is synchronizing access to shared data in a legacy library, where data that is stored and manipulated in a region of memory that has an unknown (opaque) structure although the size of the region is known. The system's memory page-fault handling mechanism is used to transparently synchronize access to shared (heap) data at the page level. In one implementation the system's page-fault handler only allows serialized access to any heap and global data in a legacy library. Threads running on separate cores that attempt to access potentially-shared data, while ownership is already taken by other threads, will wait on a lock within the page-fault handler until the owning thread has given up (yielded) control. Once the lock has been yielded, one of the threads waiting for access to the shared data is then released.

### BRIEF DESCRIPTION OF THE DRAWINGS

FIG. 1A illustrates aspects of preventing race conditions for legacy library code in accordance with an embodiment of the present invention.

FIG. 1B is a high level functional diagram illustrating synchronization of a shared memory process in a multicore processing environment using a page-fault handling mechanism is accordance with an embodiment of the present invention.

FIG. 2 illustrates aspects of synchronization of a shared memory process using locking at a page-based level in accordance with an embodiment of the present invention.

FIG. 3 illustrates a conventional page directory and page table structure in which threads of the same process share page directories and page tables.

FIG. 4 illustrates the replication of page directories and page tables to implement synchronization via page-fault handling in accordance with an embodiment of the present invention.

FIG. 5 illustrates virtual memory aspects for shared complex data in an implementation of the embodiment of FIG. 4.

FIG. 6 illustrates the implementation of synchronization via page-fault handling based on TLB cache features in accordance with an embodiment of the present invention.

### DETAILED DESCRIPTION

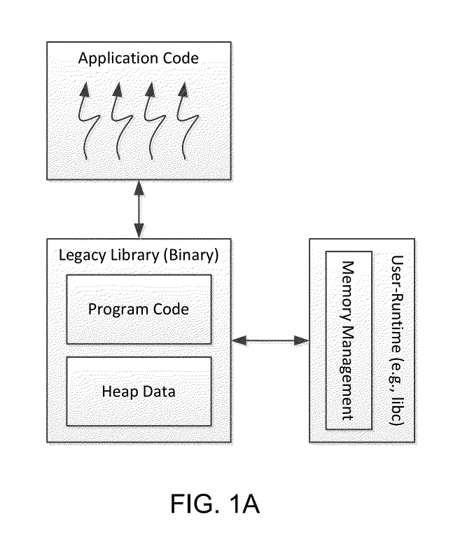

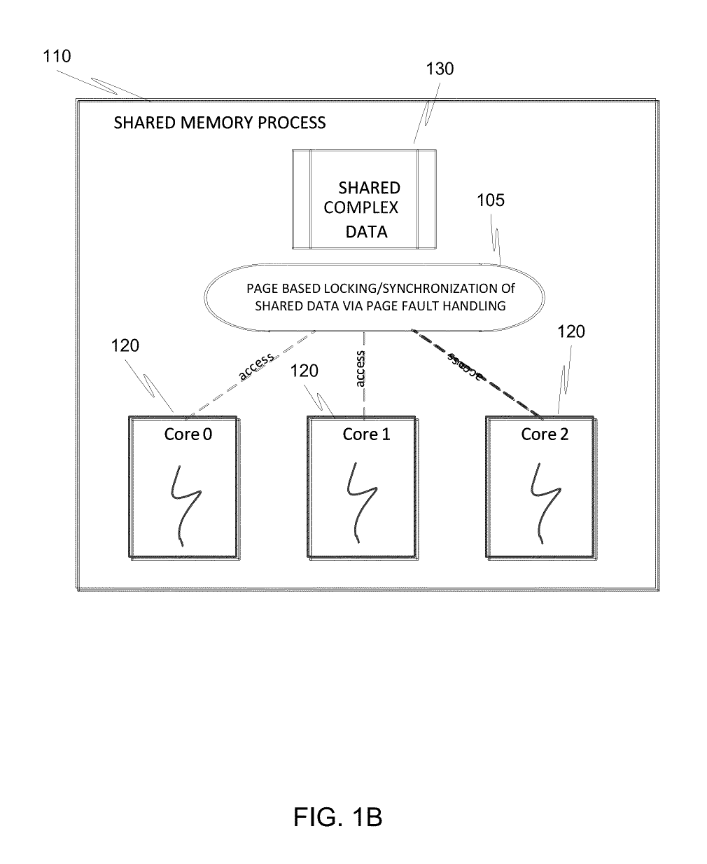

The present invention is generally directed to an apparatus, system, method and computer program product to safely share complex data across multiple concurrent threads in a multicore processing environment without explicit placement and use of conventional locks. An exemplary application of the present invention is synchronizing access to shared data in a legacy library. Referring to FIG. 1A, one aspect of the present invention is the observation by the inventors that by serializing access to heap data, a legacy library's program code (which may have been intended to execute on a uniprocessor) can be made multicore processor safe. A race condition in legacy code libraries will typically only arise in heap data and global data (data & bss section) if any. The heap access is dependent upon malloc calls or similar types of calls. The address of global data can be obtained through a linker or loader. By serializing access to heap data a legacy program can be made safe for execution on a multicore processor.

In one embodiment the OS must define a Potentially Shared Data (PSD) region. For global data, a loader will find the memory region of data and bss section when loading the library. For heap data, the original ‘malloc’ calls in the library are redirected to a specialized form of ‘malloc’, which herein we term ‘shmalloc’. Shmalloc can allocate memory from a special shared memory region that is defined by OS. Page faults associated with shared memory are differentiated by the OS page-fault handler by examination of the faulting address.

Referring to FIG. 1B, in the present invention a synchronization mechanism 105 for shared data (PSD) in a shared memory process 110 is performed via the page-fault handling mechanism. In a multicore processor environment there is a plurality of processor cores 120, each of which may execute threads of a process requiring access to shared data 130 in the shared memory process. The page-fault handling mechanism may operate via the Operating System (OS) and data structures stored in main memory.

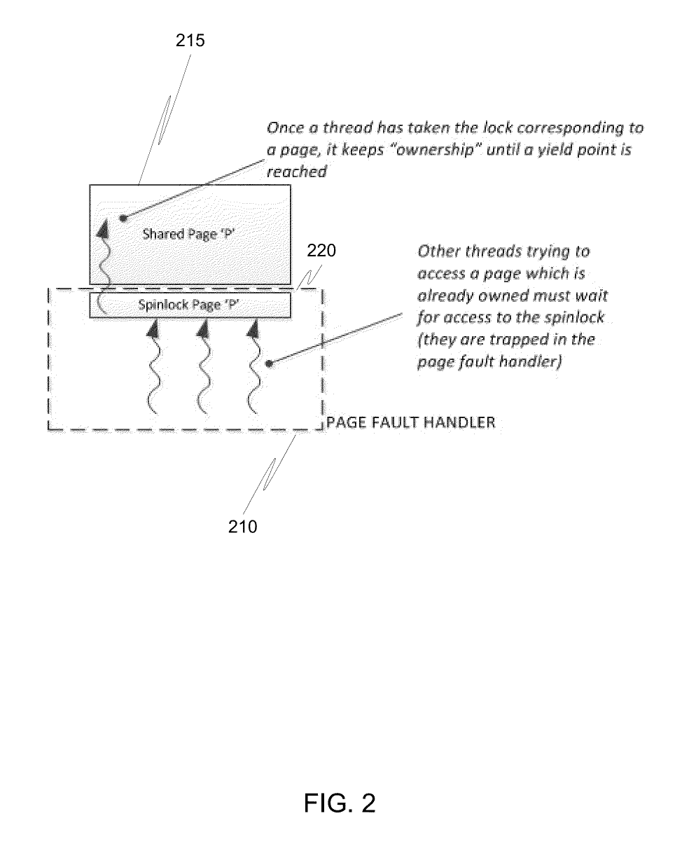

FIG. 2 is a functional diagram illustrating virtual locking of shared data using a page-fault handling. Referring to FIG. 2, locking of shared data 130 is performed by a page-fault handler 210 at a page level. It is expected that a shared data region is defined as an area of memory that has data dependencies across one or more pages. If no data dependencies exist then the shared region can be allocated as separate/individual regions.

Embodiments of the present invention are directed to eliminating the requirement for conventional data-specific locks, which have problems dealing with PSD. A page-based approach is used in which the memory page-fault handling mechanism (which is a part of existing processors and operating systems) is adapted to transparently synchronize access to shared data at the page level. Accesses to Potentially Shared Data (e.g., PSD) are synchronized by using page-fault mechanisms to serialize access. As a result, one application of the present invention is that the page-based approach may be used to safely share shared memory across multiple processors where either 1) the structure of the shared data is unknown; or 2) the code that accesses the data cannot be directly modified (e.g., reusable library).

In one embodiment of the invention, a system's page-fault handler only allows serialized access to any memory page that makes up the memory store for PSD. Threads running on separate cores that attempt to access PSD, while ownership is already taken by other threads, will wait on a lock within the page-fault handler until the owning thread has given up (yielded) control. Once the control has been yielded, a thread waiting for access to the shared data is then released.

As illustrative examples, the processor H/W Page-Fault (PF) mechanisms may be based on conventional general purpose processors such as those found on the Intel x86®, ARM® and other general purpose processors adapted to schedule serialized access to the complex shared data. While a thread is already writing to a memory page within the memory holding the shared data, all other threads are held on a lock which we term the “PSD lock”. This is a logical lock for all pages that belong to the same shared memory area. One aspect of the present invention is that once a thread has taken ownership of a PSD lock, all other threads can be forced to page-fault on an attempted access and page making up the PSD. As described below in more detail, the scheduling may be implemented in different ways. One implementation replicates the page directory and page tables. A different present bit may be presented to individual threads to force a page-fault, where the present bit is a feature of Intel-based processors. In an alternate implementation, processor hardware is used to support software-managed Translation Lookaside Buffer (TLB caches) and the ability to explicitly load individual TLB entries. In this implementation codified hardware is used to load an inconsistent TLB entry into the owning core (and thus avoiding the owning thread faulting on accesses to the page that it owns).

In the present invention, it is necessary for a thread to explicitly yield access to a PSD region. A preferred embodiment could use the library function call return point to “hook” in an explicit yield operation.

### EXEMPLARY EMBODIMENTS

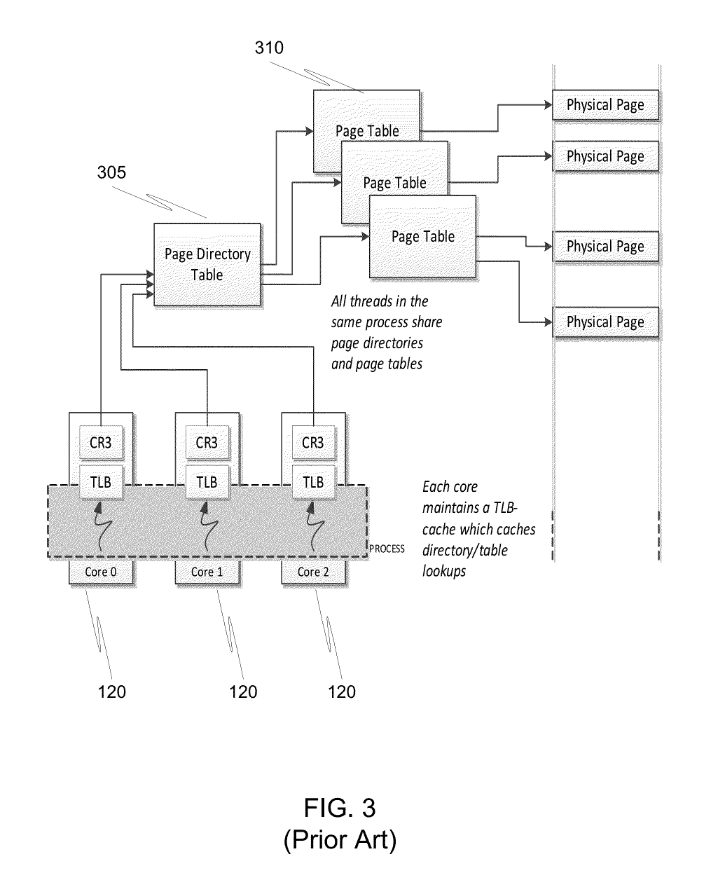

A preferred embodiment is based on duplication of page table entries. Referring to FIG. 3, conventionally, a system process in a multicore processing environment shares Page Directories (PD) 305 and Page Tables (PT) 310. Each core 120 maintains a TLB-cache which caches directory/table lookups. As an example, the Intel ia32 x86 processor architecture uses a two-level scheme of page directory and page tables. The PD base is located through the CR3 register. When a different process is context switched in, re-loading the CR3 register ensures that a different set of page tables are used. The purpose of the page tables is to resolve a virtual address to a physical address. This translation is typically done in hardware (as with the Intel ia32 architecture), however, the page directories and page tables themselves, reside in main memory and are managed by the Operating System (OS). Translations are cached by the hardware's Translation Look-aside Buffers (TLBs). In many processors, use of the TLBs is transparent; the OS is only responsible for flushing entries from the cache which is required when mappings are revoked or invalidated.

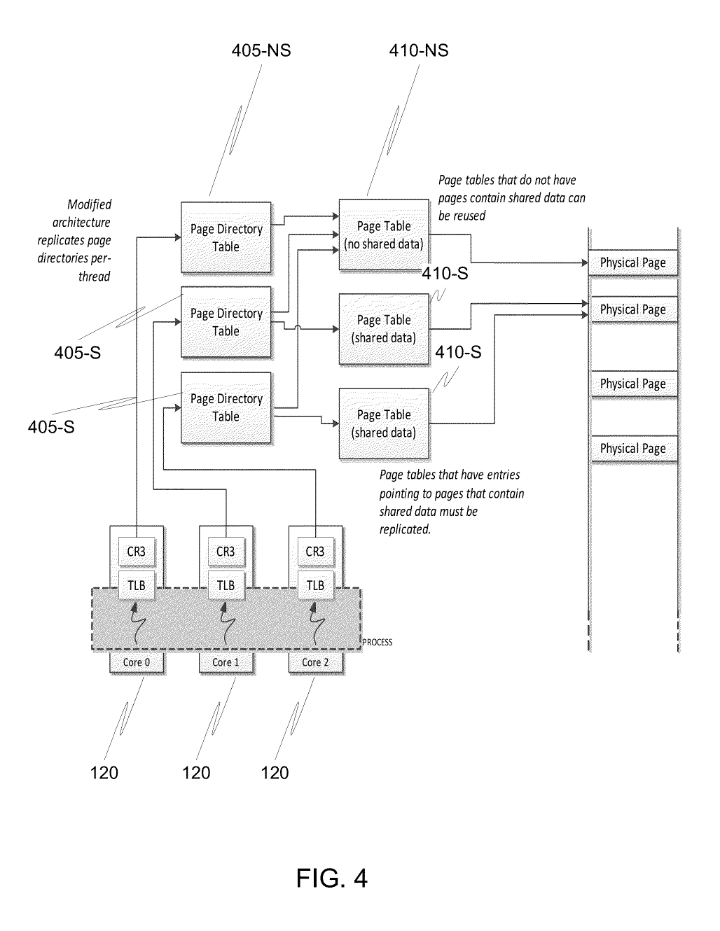

Referring to FIG. 4, one embodiment of the present invention is based on modifying the use of processing by replicated page directories 405-S and replicating page tables 415-S for shared data (S). Additionally for data that is not shared (NS) there are non-replicated page directories 405-NS and page tables 410-NS. Page directories may be replicated on a per-thread basis and page tables that have entries pointing to pages that contain shared data are always replicated. Thus, any page table entries that point to pages containing shared data (e.g., PSD) are replicated and separated out for each thread. This replication is enabled by the copying of page directories and associated page tables. Page tables that do not have any entries that point to a page containing PSD can be reused across multiple directories (i.e., separate page directories point to the same page table).

The replication and separation approaches allows threads within the same shared memory process to have different page table entries for the same region of physical memory and thus have different Page Table Entry (PTE) status bits (e.g., reserved, present). The PTE status bits are used to force a thread accessing memory to trigger page-faults PSD and hence trap into the page-fault handler. Depending on the underlying hardware architecture, clearing the P (present) bit or setting an R (reserved) bit will ensure that a page-fault is generated on access to the respective memory. The use of an R-bit is preferred since this is not normally used for other purposes (e.g., the P-bit is used by the OS to manage paging). Herein we refer to PTE bit that is used to set or clear page-fault triggering the PFT status bit.

As previously described, both page directories and page tables are replicated for shared data. Page directories may be replicated within the operating system kernel during thread creation. The replication process copies an existing page directory from some other thread belonging to the process. All page directory entries are copied (i.e. the entry is duplicated using the same page table target) except those that are marked as pointing to a Page Table that contains a PTE (Page Table Entry) pointing to a shared memory page. In an Intel ia32 embodiment, one option is using one of the “ignored bits”, e.g., bit 9, in the PDE (Page Directory Entry) to indicate the presence of complex shared data in the target page table—herein we refer to this as the “PSD Page, PSDP-bit”. The PSDP-bit is set when a PTE is created for shared data. During the replication process, any page table that is marked as shared (via the PSDP-bit in the corresponding PDE) demands that a distinct (whole) copy of the page table is made in memory.

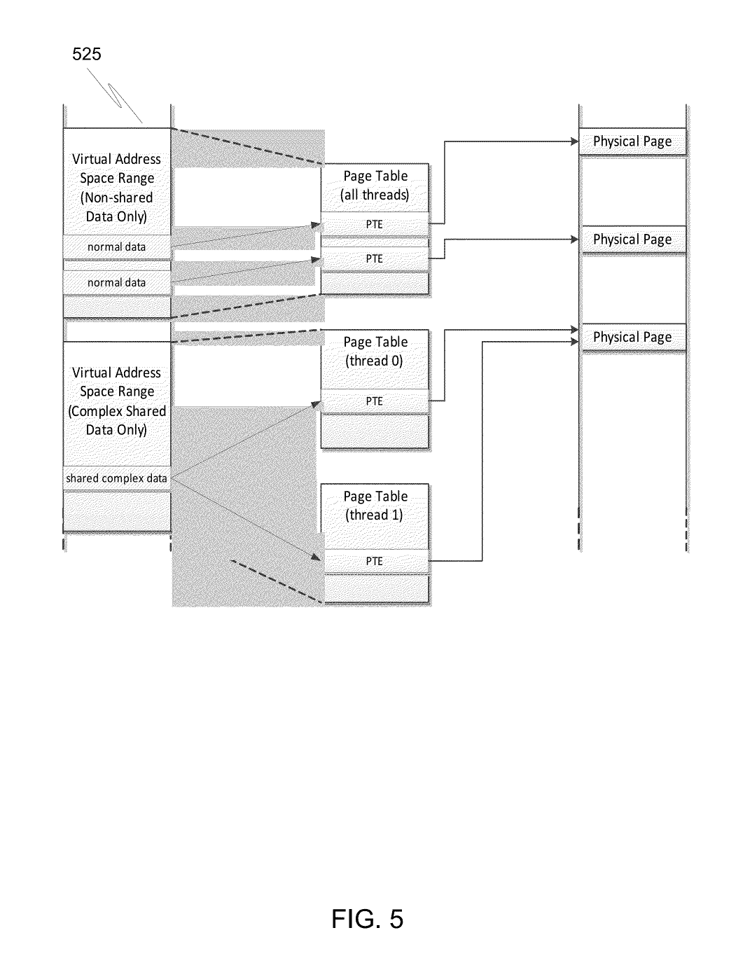

A preferred embodiment of the invention organizes virtual memory to separate complex shared data from non-shared data. That is, a page table will only contain pages that are shared or not shared, but not both. Referring to FIG. 5, for efficiency reasons, this requires that the memory allocator can allocate from specific areas of virtual memory 505 in order to ensure packing of like-pages into the same page table. Although mixing PSD and non-PSD pages in the same page table is viable, this would result in additional overhead necessary to manage the mix.

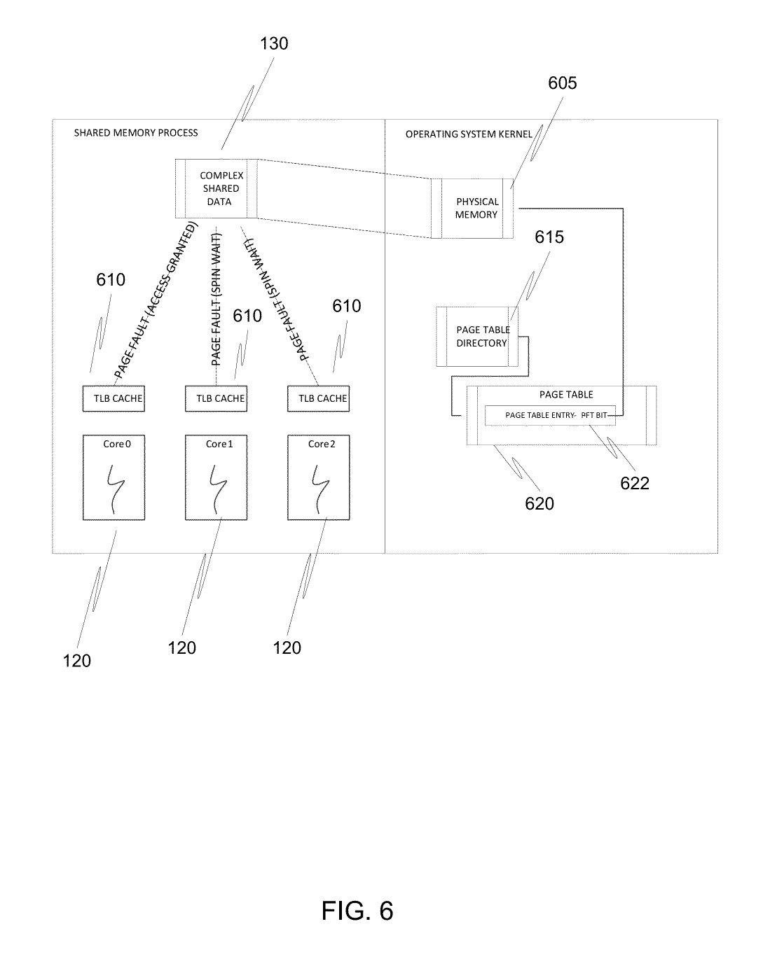

Referring to FIG. 6, an alternate embodiment is based on modifying TLB features to force page-faulting based on inconsistent TLB cache entries 610 and thus achieve synchronization of shared data. Many processors implement the system's TLB caching in software as opposed to hardware. Examples of soft-TLB processors include various incarnations of the MIPS®, Sun Microsystems UltraSPARC®, Intel Itanium®, IBM's PowerPC 600 Series®, and Freescale Semiconductor's MPC745®. These processors provide a callable instruction to explicitly load entries into the TLB cache (e.g., tlbli).

In this embodiment, the owning thread reads/writes the page using an inconsistent local TLB cache entry 610. The entry is inconsistent in that it does not match the state of the page table entry in main memory 605. Thus, other (non-owning) threads will page-fault when trying to access the same page, and thus can be synchronized in the page-fault handler as previously described in the primary embodiment, using the page table directory 615 and the PTE 620 PFT-bit 622. During ownership of the page, the owning thread can access the page using the TLB entry whilst the main memory page table entry 620 is set as not-present. The side-effect of the inconsistent TLB entry is that the owning threads will not page-fault for each read/write in the batch. The software-managed TLB capability allows the solution to directly upload entries into the TLB cache and thus achieve realize this inconsistency. When ownership is given up (yielded) the system must ensure that the local TLB entry for the respective PSD is also cleared.

While the present invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. In the description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device. In particular, methods of the present invention may be implemented as computer instructions stored on a computer readable medium. Moreover, as indicated by the previous discussion, certain aspects of the present invention may be implemented using computer program code stored in the main memory of a multicore processor system and executable by the operating system. Other features may be implemented by individual processing threads of individual processor cores.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method of synchronizing access to complex shared data in a shared memory process, comprising:
serializing access to shared data by using page-based locking via a page-fault handling mechanism of a multi-core processor;
wherein once a thread has taken ownership of a region of shared data all other threads are forced to synchronize access to the any page that makes up the shared region via the page-fault handler.

2. The method of claim 1, wherein the locking is spin locking and the method further comprises: wherein when a first thread is writing to a memory page belonging to the shared data region, holding all other threads on a lock dedicated to that region.

3. The method of claim 1, further comprising duplicating Page Table Entries (PTEs) for each processor core and presenting a different status bit to each thread.

4. The method of claim 1, wherein forcing a page-fault includes loading an inconsistent TLB entry into an owning core.

5. The method of claim 1, wherein for writes, an owning thread yields ownership of the page when it has completed a batch of writes when exiting a function within the respective library.

6. The method of 5, wherein a program compiler determines batch size.

7. The method of claim 1, wherein for read ownership, a page is yielded when all read threads have finished.

8. The method of claim 1 wherein to prevent a deadlock, a thread can hold only one page at a time and when a thread moves across a page boundary the lock is released.

9. The method of claim 1, further comprising designating multiple pages as shared memory for complex data.

10. The method of claim 1, wherein the complex data comprises data that is opaque by virtue of having a data structure that is not ascertained.

11. A system for synchronizing the protection of complex shared data in a shared memory process, comprising:
a multicore processor having a plurality of processor cores,
a page-fault handler configured to transparently synchronize access to shared data at a page level via a page-fault handler,
the page-fault handler forcing page-faults to force only a single thread to have write access at any particular time to a given page of shared data.

12. The system of claim 11, wherein the page-fault handler includes replicated page table directory tables for each processor core and replicated page tables for shared data.

13. The system of claim 12, wherein present bits are written to control access by threads.

14. The system of claim 11, wherein forcing a page-fault includes loading an inconsistent TLB entry into an owning core.

15. The system of claim 11, wherein for writes, an owning thread yields ownership of the page when it has completed a batch of writes.

16. The system of 15, wherein a program compiler determines batch size.

17. The system of claim 11, wherein for read ownership, a page is yielded when all read threads have finished.

18. The method of claim 11 wherein to prevent a deadlock, a thread can hold only one page at a time and when a thread moves across a page boundary the lock is released.

19. The method of claim 11, further comprising designating multiple pages as shared memory for complex data.

20. The method of claim 11, wherein the complex data comprises data that is opaque.
